(19) United States
(12) Patent Application Publication
(10) Pub. No.: US 2015/0082987 A1
(43) Pub. Date: Mar. 26, 2015

(54) ANTIMICROBIAL COMPOSITION COMPRISING GINSENG EXTRACT AND GREEN TEA EXTRACT, ANTIMICROBIAL FILTER AND METHOD FOR MANUFACTURING THE SAME

(71) Applicants: LG ELECTRONICS INC., Seoul (KR); Pukyong National University Industry-University Cooperation Foundation, Busan (KR)

(72) Inventors: Sunghwa LEE, Seoul (KR); Myungsuk LEE, Busan (KR)

(73) Assignees: LG ELECTRONICS INC.; Pukyong National University Industry-University Cooperation Foundation

(21) Appl. No.: 14/496,291

(22) Filed: Sep. 25, 2014

(30) Foreign Application Priority Data
Sep. 25, 2013 (KR) 10-2013-0114045

(51) Int. Cl. A01N 65/08; B01D 46/00

(52) U.S. Cl. CPC A01N 65/08; B01D 46/0028
USPC 96/226; 424/728

(57) ABSTRACT

An antimicrobial composition containing a ginseng extract and a green tea extract, an antimicrobial filter, and a method for manufacturing the same are provided, which maximize antimicrobial and antiviral effects and exhibit antimicrobial and antiviral effects using a single filter, thus advantageously having little pressure loss and enabling production at low cost in comparison to the related art, which uses two filers.

### CROSS-REFERENCE TO RELATED APPLICATION(S)

Pursuant to 35 U.S.C. §119(a), this application claims priority to Korean Patent Application No. 10-2013-0114045, filed in Korea on Sep. 25, 2013, which is hereby incorporated by reference as if fully set forth herein.

### BACKGROUND

1. Field

An antimicrobial composition containing a ginseng extract and a green tea extract, an antimicrobial filter, and a method for manufacturing the same are disclosed herein.

2. Background

In response to recently increased interest in the environment, and thus, increased demand for indoor air cleaning, a variety of air conditioning devices that remove foreign matter and microorganisms from the air have been developed. Filters are used for such air conditioning devices. These filters require various forms and properties according to types, sizes, and characteristics of objects to be removed. Accordingly, various filters suitable for these requirements have been developed.

When antimicrobial and antibacterial activities are imparted to such filters, the filters can sufficiently remove or sterilize microorganisms, such as bacteria, viruses and fungi, in the air, thus obtaining satisfactory air conditioning effects and excellent hygienic effects. The antimicrobial and antibacterial activities are further important in environments in which recirculation of air is required due to sealing for a long time and microorganisms readily propagate.

Ginseng (Panax ginseng C.A. Meyer), which is a herbaceous perennial plant belonging to the family Araliaceae and genus Panax, has been used as traditional medicines in Asia, in particular, Korea, China, and Japan, for many centuries. Ginseng is known to contain, as active ingredients, ginsenosides, polyacetylenes, alkaloids, phenolic compounds, polysaccharides, flavonoids, peptides, and fatty acids, and have an antimicrobial function.

Green tea (Camellia teaceac) is known to provide nutrients, such as vitamins and minerals, and satisfy preferences, such as taste and flavor. A main ingredient imparting an astringent taste to green tea is catechin, which belongs to polyphenols. Catechin is classified into epicatechin, epigallocatechin, epicatechin gallate, and epigallocatechin gallate according to derivatives thereof. Catethin is present in an amount of about 8 to 20% in dried green tea, is water-soluble, and is released into water when dried green tea is boiled in water. Further, green tea contains a variety of physiologically active substances. In particular, catechin is found to function to reduce LDL cholesterol in blood to suppress thrombosis and prevent arteriosclerosis, suppress formation of peroxide lipids and prevent fat oxidation, and is also used as a natural antioxidant. In addition, green tea provides anti-aging functions, suppresses generation and propagation of cancers, and prevents food poisoning due to antitoxic activity of inactivating toxins.

Disadvantageously, antimicrobial filters effective for bacteria and antiviral filters effective for viruses are separately used because antimicrobial filters using plant extracts developed to date are coated with a single substance. Antimicrobial filters developed to date have only a single function, and thus, have a problem of increased manufacturing costs or increased pressure loss when applied to products.

### DETAILED DESCRIPTION

Unless otherwise mentioned, the term “antimicrobial” means removal of bacteria, as well as removal of fungi and viruses.

The antimicrobial composition according to an embodiment contains a ginseng extract and a green tea extract wherein the ginseng extract and the green tea extract may be present in a weight ratio of about 60:40 to 70:30. The term “ginseng extract” means an extract of ginseng and may include an extract of unprocessed ginseng, as well as processed ginseng, such as red ginseng or black ginseng. The ginseng extract may be selected from a ginseng rootlet extract extracted from ginseng rootlets, a ginseng leaf extract extracted from ginseng leaves, a ginseng main root extract extracted from ginseng main roots, a fermented ginseng rootlet extract obtained by fermenting and extracting ginseng rootlets, a fermented ginseng leaf extract obtained by fermenting and extracting ginseng leaves, and a fermented ginseng main root extract obtained by fermenting and extracting ginseng main roots and a combination thereof.

The ginseng extract is safe to humans and is effective in removing or sterilizing microorganisms. More specifically, the ginseng extract is highly effective in removing general bacteria, as well as pathogenic bacteria, such as food poisoning bacteria and is effective in removing viruses, which are causes of infectious diseases, such as avian influenza or swine flu, or fungi, such as filamentous fungi which are difficult to remove due to propagation by spore, thus exhibiting excellent antimicrobial and antibacterial effects upon a wide range of microorganisms. Further, the ginseng extract may be extracted from ginseng used as a medicine or food additive, and thus, is harmless to humans, thus being applicable to areas where humans and food come into direct contact.

When the ginseng extract is prepared using a ginseng by-product selected from a group consisting of ginseng rootlets, ginseng leaves, and a combination thereof, the ginseng extract may be prepared using ginseng by-products having low applicability as ginseng, the medicinal ingredient, or ginseng wastes, thereby advantageously providing improved economic efficiency and excellent environmental effects. In particular, among the ginseng extracts, the fermented ginseng extract obtained by fermenting and extracting a ground ginseng product selected from a group consisting ginseng rootlets, ginseng main roots, ginseng leaves, and a combination thereof may improve antimicrobial and antibacterial effects of ginseng by fermentation.

Further, among the ginseng extracts, the ginseng leaf extract, the fermented ginseng rootlet extract, and the fermented ginseng main root extract have considerably better antimicrobial and antibacterial effects than other extracts, and in particular, the ginseng leaf extract and the fermented ginseng rootlet extract have superior antibacterial effects and excellent economical and environmental effects. The ginseng extract may contain one selected from a group consisting of a ginseng extract, a concentrated ginseng extract, a dried ginseng extract, and a combination thereof. When the concentrated ginseng extract or the dried ginseng extract is used as the ginseng extract, the ginseng extract may be easily stored and transported and may maintain antibacterial and antimicrobial functions. The dried ginseng extract may be a dried or freeze-dried powder of the ginseng extract.

The term “green tea extract” means an extract of green tea and may include an extract of unprocessed green tea, as well as an extract of processed green tea. The green tea extract may be selected from a green tea extract extracted from green tea, a fermented green tea extract obtained by fermenting and extracting green tea, and a combination thereof. The fermented green tea extract may improve antimicrobial and antibacterial effects of the green tea extract by fermentation.

The green tea extract may contain one selected from a group consisting of a green tea extract, a concentrated green tea extract, a dried green tea extract, and a combination thereof. When the concentrated green tea extract or the dried green tea extract is used as the green tea extract, the green tea extract may be easily stored and transported and may maintain antibacterial and antimicrobial functions. The dried green tea extract may be a dried or freeze-dried powder of the green tea extract.

In the antibacterial composition according to embodiment, a weight ratio of the ginseng extract to the green tea extract may be about 50:50 to 80:20, about 60:40 to 70:30, even about 62:38 to 68:32, or about 66:34. When the ginseng extract and the green tea extract are mixed at this ratio, maximum antibacterial and antiviral effects may be obtained. When the weight ratio of ginseng extracts is lower than the range defined above, for example, antimicrobial activity against E. coli may be remarkably reduced, and when the weight ratio of the green tea extracts is less than the range defined above, for example, a function deterioration problem in which feline calcivirus (FCV) cannot be removed within a short time, for example, about 3 hours, even about 2 hours occurs.

The antimicrobial composition according to embodiments may further include at least one additive in addition to the active ingredients, and the additives may be freely selected without limitation according to composition of stock solution.

The amount of active ingredients containing the ginseng extract and the green tea extract is about 0.01 to 100% by weight, about 0.1 to 70% by weight, or about 1 to 10% by weight, with respect to a total weight of the composition; however, embodiments are not limited thereto. Water, as well as the active ingredients and the additive may be added to adjust a total weight to 100% by weight so that a stock solution having a desired composition may be prepared.

In addition, a variety of formulations may be prepared using the active ingredient or the stock solution containing the active ingredient. The formulations may be any type of formulations prepared in the art, and examples thereof may include, but are not limited to, solutions, emulsions, suspensions, pastes, gels, creams, lotions, soaps, oils, powders, waxes, and sprays.

A method for preparing the antimicrobial composition according to an embodiment may include preparing a ginseng extract; preparing a green tea extract; and mixing the ginseng extract with the green tea extract. The mixing may be carried out by mixing the ginseng extract with the green tea extract at a weight ratio of about 60:40 to 70:30. The preparation of the ginseng extract and the preparation of the green tea extract may further include powderizing the prepared ginseng and green tea extracts, respectively, and the powderization may be for example, carried out by concentrating the resulting extracts under reduced pressure. The preparation of the ginseng extract and the preparation of the green tea extract may be exchanged in order or simultaneously performed.

The preparation of the ginseng extract may include grinding any one selected from a group consisting of ginseng leaves, ginseng rootlets, ginseng main roots and a combination thereof to prepare a ground ginseng (grinding); mixing the ground ginseng with distilled water and sterilizing the resulting mixture (sterilization); air-cooling the sterilized mixture; and drying the mixture and extracting the dried mixture with a solvent (extraction). The preparation of the green tea extract may include grinding green tea to prepare a ground green tea (grinding); mixing the ground green tea with distilled water and sterilizing the resulting mixture (sterilization); air-cooling the sterilized mixture; and drying the mixture and extracting the dried mixture with a solvent (extraction).

Any device for the grinding may be used so long as it is capable of grinding the ginseng leaves, ginseng rootlets, ginseng main roots, or green tea. The device may be for example, a homogenizer. A size of ground ginseng or green tea product is not particularly limited, and may be applied without limitation so long as it improves efficiency of sterilization and extraction.

Any method for sterilization may be used so long as it is capable of sterilizing the ground ginseng or green tea product, and may be high-pressure steam sterilization, in which the mixture prepared by mixing the ground ginseng or green tea product with distilled water is sterilized under high-pressure steam. The high-pressure steam sterilization may be for example, carried out by treating the mixture at about 1.2 atm and at about 121° C. for about 15 minutes or longer. The sterilization removes unnecessary microorganisms contained in the ground ginseng or green tea product, and enables easy extraction from the ground ginseng or green tea product.

The air-cooling may be, for example, cooling the sterilized mixture, and may be, for example, carried out by standing the mixture at room temperature for about 12 hours.

In the extraction, the ground ginseng or green tea product may be mixed with a solvent, and may then be extracted. Any solvent may be used without particular limitation so long as it is capable of dissolving the ground ginseng and green tea product. The solvent may be, for example, water, methanol, or ethanol. A process for preparation of the ginseng extract or green tea extract may be used without particular limitation so long as active ingredients can be extracted from the ground ginseng and green tea products, and may be, for example, extraction under stirring in a mantle while mixing with methanol. The extraction may be carried out at a temperature of about 40 to 100° C., or about 50 to 75° C. The extraction may be repeated two, three, or four times.

The preparation method may further include powderizing the prepared ginseng and tea extract extracts after extraction, and the powderization may include concentrating and powderizing the extracted ginseng or green tea extract to prepare a ginseng or green tea extract powder, and more specifically, may be carried out by concentrating and powderizing the ginseng extract or the green tea extract by concentration under reduced pressure.

The antimicrobial filter according to embodiment may contain a ginseng extract and a green tea extract, and a weight ratio of the ginseng extract to the green tea extract may be 60:40 to 70:30. In addition, the antimicrobial filter may further contain any one selected from a group consisting of an antimicrobial substance, a binder, a metal, and a combination thereof.

Any antimicrobial substance may be used without limitation so long as it is known to have sterilization, antimicrobial, or antibacterial effects. The antimicrobial substance may include any one selected from a group consisting of glutaraldehyde, phthalaldehyde (PA), potassium disulfite (PD), bronopol, sodium deoxycholate, quaternary ammonium, and a combination thereof. These substances used as antimicrobial substances are demonstrated to be safe enough to be used in foods, improve antimicrobial and antibacterial effects of the filter, and are harmless to humans. In particular, glutaraldehyde is effective in inhibiting activity of microorganisms by linking proteins and thereby immobilizing enzymes, the sodium deoxycholate is effective in inhibiting cell growth by affecting cell membranes, and the quaternary ammonium increases pH and thereby has negative effects on survival conditions of microorganisms.

The binder may fix the ginseng extract or the green tea extract on carriers supporting the ginseng or green tea extract, or filters having a function of the carriers as well as the effect of removing foreign matter through general air filtering and binds the ginseng extract or green tea extract on the carriers or filters in spite of air pressure loads of carriers or filters. Any binder may be used without particular limitation, so long as it is capable of binding the ginseng extract or green tea extract on the carriers or filters.

The binder may be an antimicrobial binder having both adhesion force and antimicrobial function, such as polyvinylpyrrolidone iodine (PVPI), norspermidine (NS, bis(3-aminopropyl)octylamine) and a combination thereof. The binder may be an organic-inorganic hybrid binder, such as silicon-modified epoxy resin, silicon-modified acrylic resin, silicon-modified urethane resin, silicon-modified vinyl resin, polyvinyl alcohol silicone resin, urethane resin, acrylic resin, vinyl resin, silicone resin, or a combination thereof, for example, silicon-modified epoxy resin.

In the organic-inorganic hybrid binder, a silane compound, such as organosilane or alkoxysilane for silicon modification of the binder, may be selected from a group consisting of methyltrichlorosilane, vinyltrichlorosilane, 3-glycidoxypropyltrimethoxysilane, tetraethyl orthosilicate, 3-aminopropyltrimethoxysilane, 3-methacryloxypropyltri-methoxysilane, vinyltrimethoxysilane, and combinations thereof. The silicon-modified organic-inorganic hybrid binder may be prepared by hydrolyzing the silane compound with the binder resin in the presence of a solvent, such as water or alcohol. In this process, a hydrolysis catalyst may be used. The hydrolysis catalyst may be an inorganic acid, such as hydrochloric acid, sulfuric acid, or nitric acid.

The binder may be used as a combination of the antimicrobial binder and the organic-inorganic hybrid binder. In this case, the binder may have antimicrobial or antibacterial activities while sufficiently fixing the ginseng extract or green tea extract on the carriers or filters, thus improving antimicrobial or antibacterial functions of the filter. In particular, when polyvinylpyrrolidone iodine (PVPI) is used as the binder, sufficient adhesive effect may be obtained in spite of using a small amount of the binder, and at the same time, improvement of antimicrobial or antibacterial properties may be achieved as well, due to the superior antibacterial property.

In addition, the antimicrobial filter may further contain a carrier and any carrier may be used without limitation so long as it is capable of supporting or coating the ginseng extract or the green tea extract to fix the same. There is no limitation as to type, shape, size, and production method of the carrier so long as the carrier is contained in the filter or has the inherent function of the filter.

The carrier may be composed of fabrics, metals, or plastics, and may include any one selected from a group consisting of non-woven fabrics, paper fibers, glass fibers, ion exchange fibers, cellulose fibers, asbestos fibers, activated carbon, titanium dioxide, zinc, copper, aluminum, and combinations thereof. The carrier may be produced as a variety of shapes including honeycomb, particle, net, filter paper, cotton, mesh, plate, and groove shapes, and these shapes may be modified or combined with one another. In addition, the carrier may be a deodorization filter, such as an activated carbon filter used in conventional home appliances, such as refrigerators and air conditioners, a HEPA filter, or a filter for air conditioners of vehicles, or may contain the same. The non-woven fabric may be a dry or wet non-woven fabric, and the dry non-woven fabric may include polypropylene (PP), polyethylene terephthalate (PET), polyethylene (PE), polyamide, nylon, and a combination thereof.

In addition, the carrier may be an air filter. Any air filter may be used so long as it is used as a conventional air filter. More specifically, the carrier may be a non-woven fabric including polypropylene and may be a zebra-shaped filter.

In particular, when the air filter serving as the carrier and having the effect of removing foreign matter, such as dust, by general air filtering is used as the antimicrobial filter, it imparts both an air conditioning function and antimicrobial and antibacterial properties to the air conditioning filter, thus improving performance of air conditioning filter.

The antimicrobial filter may further include a metal. In this case, antimicrobial and antibacterial performance of the air conditioning filter may be improved. The metal may include any one selected from a group consisting of Ag, Cu, Zn, Ca, Mn and a combination thereof and may be a metal sol form. The antimicrobial filter may have a configuration in which the ginseng extract, the green tea extract, the antimicrobial substance, the binder, and the metal are supported or coated on the carrier. The supporting or coating may be carried out by a well-known method, for example, dipping, rolling, or spraying; however, embodiments are not limited thereto. When the ingredients are coated on the carrier, the coating layer may have a thickness of several nanometers to several micrometers.

The antimicrobial filter may contain the ginseng extract and the green tea extract in an amount of about 0.001 to 30% by weight, about 0.1 to 10% by weight, or about 0.3 to 5% by weight, based on a total weight of ingredients. When the content of the ginseng extract and the green tea extract is less than about 0.001% by weight, the antimicrobial activity may be insufficient and when the content exceeds about 30% by weight, economic efficiency may be deteriorated. In addition, when the antimicrobial filter contains the ginseng extract and the green tea extract in the content range defined above, harmlessness to humans and sufficient antimicrobial activity may be imparted to the air conditioning filter coated with the same.

The antimicrobial substance may be present in an amount of about 0.0001 to 10% by weight, about 0.01 to 5% by weight, or about 0.08 to 3% by weight, with respect to the total weight of ingredients. When the antimicrobial substance is used in an amount less than about 0.0001% by weight, reinforced antimicrobial activity is disadvantageously deteriorated, and when used in an amount higher than about 10% by weight, improvement in antimicrobial effect as compared to the used amount may be insufficient. Accordingly, the range defined above may be maintained.

The binder may be present in an amount of about 0.001 to 40% by weight, or about 0.01 to 30% by weight, based on the total weight of ingredients. When the binder is used in an amount less than about 0.001% by weight, it is disadvantageously difficult to fix the extract on the carrier or the filter, and when the binder is used in an amount higher than about 40% by weight, it may have a negative effect on viscosity. Thus, the range defined above may be maintained.

The antimicrobial filter is, for example, obtained by applying, to a carrier, a coating solution containing about 1 to 10% by volume of ginseng extract and green tea extract solutions prepared by dissolving the ginseng extract and the green tea extract in a first solvent selected from a group consisting of water, ethanol and a combination thereof, about 0.05 to 1% by volume of a antimicrobial substance, about 1 to 10% by volume of a metal, and about 79 to 93% by volume of a binder solvent consisting of a binder and a second solvent. When the coating solution is applied, miscibility and coatability of the coating solution may be improved.

The binder solvent may contain the binder and the second solvent in amounts of about 20 to 30% by volume and about 70 to 80% by volume, respectively. The second solvent may be any one selected from a group consisting of water (pure water), ethanol, and a combination thereof.

The method may further include suitably drying the coating solution when the coating solution is supported or coated on the carrier.

The ingredients may be present in amounts enabling antimicrobial performance and adhesion performance (the capability of coating the ingredients on the carrier to maintain the antimicrobial performance). More specifically, a weight ratio of a total weight of the ginseng extract, the green tea, extract and antimicrobial substance to the binder may be about 1:2 to 1:80, about 1:5 to 1:40, or about 1:7.5 to 1:10. When the ingredients are used in the weight ratio defined above, antimicrobial performance and adhesive performance required for the air conditioning filter may be optimized and economic efficiency improved. The metal may be present in an amount of about 1 to 10-fold by weight, based on the total weight of the ginseng extract and the green tea extract, and the antimicrobial substance may be present in an amount of about 0.01 to 10-fold by weight, based on the total weight of the ginseng extract and the green tea extract.

The antimicrobial filter may contain the ginseng extract and the green tea extract, thus being harmless to humans, exhibiting superior antimicrobial and antibacterial effects and having an air conditioning function, as well as the effect of potently removing microorganisms due to effects of efficiently removing general bacteria, as well as pathogenic bacteria, such as food poisoning bacteria, viruses and fungi, and thus, a deodorization effect.

Due to these properties, any antimicrobial filter may be applied to any device requiring the air conditioning filter, for example, home appliances, such as air conditioners, air cleaners, a refrigerator, facial treatment devices, and stylers, or vehicle air conditioners to circulate indoor air. In addition, the antimicrobial filter may be used as a filter, such as a deodorization filter or a HEPA filter, or may be used in conjunction therewith.

### EXAMPLE

Hereinafter, embodiments will be described in detail which may be easily implemented by those having an ordinary skill in the art. However, embodiments may be implemented in various different forms, and thus, are not limited to embodiments described herein.

### Preparation Example

### Preparation of Mixture of Ginseng Extract and Green Tea Extract

(1) Preparation of Active Ingredient Extract of Ginseng

Ginseng rootlets and ginseng leaves were ground using a homogenizer to prepare a ground ginseng product (grinding). About 30 g of the ground ginseng was mixed with about 600 ml of distilled water to prepare a mixture, and the mixture was sterilized at about 121° C. for 15 minutes using a high-pressure steam sterilizer (sterilization). The sterilized mixture was cooled in the air. The air-cooled mixture was dried, and about 600 g of the ground powder was incorporated in about 6 L of methanol and stirred and extracted three times in a mantle for about 3 hours, followed by filtering, to prepare a ginseng extract (extraction). The ginseng extract was concentrated under reduced pressure using a rotary vacuum evaporator and an about 45° C. constant-temperature bath, and then powderized to prepare a ginseng extract powder (powderization).

(2) Preparation of Active Ingredient Extract of Green Tea

Green tea was ground using a homogenizer to prepare a ground green tea product (grinding). About 30 g of the ground green tea product was mixed with about 600 ml of distilled water to prepare a mixture and the mixture was sterilized at about 121° C. for about 15 minutes using a high-pressure steam sterilizer (sterilization). The sterilized mixture was cooled in the air. The air-cooled mixture was dried and about 600 g of the ground powder was incorporated in 6 L of methanol and stirred and extracted three times in a mantle for about 3 hours, followed by filtering, to prepare a ginseng extract (extraction). The green tea extract was concentrated under reduced pressure using a rotary vacuum evaporator and an about 45° C. constant-temperature bath, and then powderized to prepare a green tea extract powder (powderization).

(3) Preparation of Mixture of Ginseng Extract and Green Tea Extract

The ginseng extract powder and the green tea extract powder obtained in (1) and (2) were dissolved in de-ionized water, such that solutions having concentrations of about 5 mg/ml were obtained. The ginseng extract and the green tea extract dissolved in distilled water were mixed at various ratios and were used in the following process.

### Test Example

### Method Used for Testing Antimicrobial and Antiviral Performances

1. Evaluation of Antimicrobial Performance Using Shaking Flask Method

A shaking flask method was used to test antimicrobial effects against E. coli and S. aureus. A maintenance medium inoculated with about 105 (cfu/ml) of E. coli or S. aureus was prepared using about 1% nutrient broth and about 0.5% NaCl. The substances of Comparative Example and Example were reacted with the maintenance medium at a temperature of about 35° C. After a predetermined time, antimicrobial effect was evaluated using a pour plate method. The antimicrobial effect was calculated using the following equation:

$$Antimicrobial effect ( \% ) = ( \frac{Mc - Me}{Mc} ) \times 100$$

Me: the number of bacteria in maintenance medium containing the substances

Mc: the number of bacteria in maintenance medium not containing the substances

2. Evaluation of Viral Removal Performance to Feline Calcivirus (FCV)

Antiviral performance was evaluated using a Feline calcivirus (FCV F9 strain, cat. # VR-782-ATCC), which is similar genetic structure and physical and chemical properties to norovirus and belongs to the same group, Caliciviridae. Virus removal effect was identified by checking infection according to virus reaction time using Crandell's feline kidney (CrFK) cells (ATCC, CCL-94).

An Eagle's minimum essential medium MEM (10% FBS or HS) was added to a 75 cm2 cell culture flask and cultured in an about 5% CO2 incubator at about 37° C. for one night. The cells were subcultured every two days, inoculated with FCV F9 strains and cultured in an about 5% CO2 incubator at about 37° C., and whether or not the virus was cultured in the prepared sample was identified to prepare cells and viruses.

CrFK cells were seeded at a density of about 1.3×104/100 ul on a 96 well cell culture plate and cultured in an about 5% CO2 incubator at about 37° C. for one night.

On the next day, the prepared virus was 10-fold diluted with a maintenance medium by a decimal method. A growth medium was removed on a 96 well-plate composed of a single membrane using an aspirator, and each of eight wells was inoculated with about 25 μl of the diluted virus.

The cells were inoculated with the virus in an about 5% CO2 incubator at about 37° C. for 90 minutes and about 100 μl of a maintenance medium was added to each well. A viral titer was determined by comparing the amount of viruses left after reacting with the extract for a predetermined time with a control group and calculating TCID (tissue culture infectious dose)50 measured in CrFK cells.

On the fifth day of viral culture, cells dissolved by viruses were visualized and a dilution process of wells exhibiting about 50% or more of cytopathic effect (CPE) was determined by the Reed-Munch method and was represented as Log TCID50.

### Comparative Example 1

### Use of Green Tea Extract Alone

Antimicrobial performance was evaluated using green tea extract alone by the method according to Test Example. Results are shown in Table 1 below.

TABLE 1
Test results of antimicrobial performance of green tea extract

| | | Test strains and reaction time | | | |
|---|---|---|---|---|---|
| | | E. coli | | A. niger | FCV |
| sample | | (24 hr) | S. aureus | (48 hr) | (1 hr) |
| Green tea | Non- | 0% | 99.98% | 28.57% | 100% |
| extract | fermentation | | (24 hr) | | |
| | Fermentation | 0% | 100% | 33.33% | 100% |
| | | | (3 hr) | | |

As can be seen from Table 1 above, the green tea extract was found to inactivate 100% FCV after reacting with FCV for one hour or have no antimicrobial activity against E. coli.

### Comparative Example 2

### Use of Ginseng Extract Alone

Antimicrobial performance was evaluated using the ginseng extract alone by a method according to Test Example. Results are shown in Table 2 below.

TABLE 2
Test results of antimicrobial performance of ginseng extract

| | Test strains and reaction time | | | |
|---|---|---|---|---|
| | E. coli | S. aureus | A. niger | FCV |
| Sample | (24 hr) | (3 hr) | (48 hr) | (6 hr) |
| Ginseng extract | 100% | 100% | 90.95% | 100% |

As can be seen from Tables 1 and 2 above, when the ginseng extract was used alone, 100% of E. coli and S. aureus were removed within 24 hours and 100% of FCV (tested instead of norovirus) was inactivated after reaction for 6 hours. That is, regarding antiviral activity, the ginseng extract exhibited about a 6-fold longer time required for 100% inactivation than the green tea extract.

Consequently, as can be seen from Tables 1 and 2, when the respective extracts were used alone, they did not exhibit complete and rapid antimicrobial and antibacterial effects against all strains.

### Examples 1 to 5

### Use of Combination of Ginseng Extract and Green Tea Extract

Antimicrobial performance of a mixture of the ginseng extract (ginseng) and the green tea extract (green tea) was tested. The results shown in Tables 3 and 4 below were obtained.

TABLE 3
Test results of antimicrobial performance of combination of ginseng
and green tea extracts on E. coli and Staphylococcus Aureus

| | Strain and reaction time | | | |
|---|---|---|---|---|
| | E. coli | | Staphylococcus | |
| ginseng:green tea | (Escherichia coli) | | Aureus | |
| (weight ratio) | 5 hr | 24 hr | 3 hr | 5 hr |
| (Comparative Example 2) | 99.96% | 100% | 100% | 100% |
| 100:0 | | | | |
| (Example 1) 90:10 | 99.87% | 99.99% | 100% | 100% |
| (Example 2) 80:20 | 99.71% | 99.99% | 100% | 100% |
| (Example 3) 66:34 | 99.24% | 99.99% | 100% | 100% |
| (Example 4) 50:50 | 98.99% | 99.99% | 100% | 100% |
| (Example 5) 34:66 | 98.68% | 99.99% | 100% | 100% |
| (Comparative Example 1) | 0% | 0% | 100% | 100% |
| 0:100 | | | | |

TABLE 4
Test results of antimicrobial performance of combination of ginseng
and green tea extracts on FCV (TCID50)

| ginseng:green tea | Reaction time | | | | |
|---|---|---|---|---|---|
| (weight ratio) | 30 min | 1 hr | 2 hr | 3 hr | 6 hr |
| (Comparative | — | 98.83% | 97.50% | 97.50% | 100% |
| Example 2) 100:0 | | | | | |
| (Example 1) 90:10 | — | 95.28% | 96.00% | 98.67% | 100% |
| (Example 2) 80:20 | — | 97.67% | 99.86% | 100% | 100% |
| (Example 3) 66:34 | — | 98.93% | 100% | 100% | 100% |
| (Comparative | 98.00% | 100% | 100% | 100% | 100% |
| Example 1) 0:100 | | | | | |

* “—” in Table 4 indicates that antimicrobial effect was not determined.

As can be seen from Table 3 above, upon reaction for 24 hours, 100% of E. coli was removed when the ginseng extract was used alone, and 99.99%, 99.99%, and 99.97% of E. coli was removed when the ginseng extract and the green tea extract were used at a ratio of 90:10, 80:20, and 66:34, respectively. 100% of Staphylococcus Aureus was removed upon reaction for three hours under all the mixing ratio conditions.

In addition, as can be seen from Table 4, as a result of measurement of antiviral performance, 100% inactivation was observed upon reaction for one hour when the green tea extract was used alone, 100% inactivation was observed upon reaction for six hours when the ginseng extract was used alone, and 100% inactivation was observed upon reaction for six, three and two hours when the ginseng extract and the green tea extract were combined in ratios of 90:10, 80:20, and 66:34, respectively.

The results indicated that, when the ginseng extract and the green tea extract were mixed at a weight ratio of 66:34 (Example 3), 99.99% (24 hr), and 100% (3 hr) of E. coli and S. aureus were removed, respectively, and 100% inactivation of FCV was observed upon reaction for two hours. In this case, overall, a most superior effect was obtained.

TABLE 5
Overall results of antimicrobial activity of mixture of ginseng
extract and green tea extract weight ratio of 66:34

| | Test strain | | |
|---|---|---|---|
| | | Yellow Staphylococcus | |
| | E. coli | Aureus | |
| samples | (24 hr) | (3 hr) | FCV |
| (Example 3) 66:34 | 99.99% | 100% | 100% (2 hr) |

### Example 6

### Preparation of Antimicrobial Filter and Evaluation of Antimicrobial Performance

(1) Preparation of Antimicrobial Filter

An air conditioning filter was produced using a zebra-shaped filter (produced by Lyusen Corporation) as a carrier. An antimicrobial filter was produced by mixing the produced ginseng extract and the green tea extract with the antimicrobial substance, and the binder shown in Table 6 at respective concentrations. A great amount of ethanol was added to the green tea extract because the green tea extract exhibits superior solution stability in an ethanol solvent. A natural extract may be added in an amount higher than about 5% by weight, but was added in a reduced content as shown in the following table due to excessively deep color. As to the content of metal sol, the anti-fungi effect is advantageously improved when an overall copper concentration is increased. When about 20% or more of a silicone-modified epoxy binder is used, stability of the solution may be reduced. Accordingly, the silicone-modified epoxy binder is used in conjunction with a PVA #500 silicone binder.

TABLE 6
Ingredients and ratios of antimicrobial filter

| | | Content |
|---|---|---|
| | Ingredients | (% by weight) |
| Natural extracts | Ginseng extract | 1.32 |
| | Green tea extract | 0.68 |
| Antimicrobial | Glutaraldehyde | 1 |
| substance | | |
| Binder | Silicone-modified epoxy binder | 15 |
| | polyvinyl alcohol(PVA #500) | 10 |
| | silicone binder | |
| Metal sol | Ca, Zn, Cu, Ag sol | 10 |
| Solvent | Pure water | 12 |
| | Ethanol | 50 |
| Total | | 100 |

(2) Evaluation of Filter Performance

The antimicrobial effect was measured using the produced antimicrobial filter, and a filter was produced only using about 2% by weight of the ginseng extract without using the green tea extract among the ingredients of Comparative Example and testing by comparison was performed. Results measured after about 10 minutes of the antimicrobial activity are shown in the following Table 7.

TABLE 7

| | Tests strains | | | |
|---|---|---|---|---|
| | | Yellow | | Anti- |
| | | Staphylococcus | | fungal |
| Configuration | E. coli | Aureus | FCV | activity |
| Ginseng extract alone | 99.91% | 99.93% | 99.20% | Grade 0 |
| Mixture (66:34) of | 100% | 100% | 100% | Grade 0 |
| ginseng extract and | | | | |
| green tea extract | | | | |

As can be seen from Table 7 above, the antimicrobial filter according to embodiments eliminated 100% of E. coli and yellow Staphylococcus Aureus upon reaction for about 15 minutes and inactivated 100% of FCV, and had an antifungal activity of grade zero, thus exhibiting superior effects as compared to the filter using the ginseng extract alone.

As apparent from the fore-going, embodiments disclosed herein provide an antimicrobial composition containing a ginseng extract and a green tea extract, an antimicrobial filter, and a method for manufacturing the same which maximize maximum antimicrobial and antiviral effects, and exhibit antimicrobial and antiviral effects using a single filter, thus advantageously having little pressure loss and enabling production at low cost as compared to the related art using two filers.

Accordingly, embodiments disclosed herein are directed to an antimicrobial composition containing a ginseng extract and a green tea extract, an antimicrobial filter, and a method for manufacturing the same that substantially obviate one or more problems due to limitations and disadvantages of the related art.

Embodiments disclosed herein are to provide an antimicrobial composition containing a ginseng extract and a green tea extract with highly efficient antibacterial and antiviral effects, an integral antimicrobial filter having excellent antibacterial and antiviral effects and little pressure loss, and methods for manufacturing the same. In particular, embodiments disclosed herein are to provide an antimicrobial composition containing a ginseng extract and a green tea extract at an optimum ratio to provide maximum antibacterial and antiviral effects, an antimicrobial filter, and a method for manufacturing the same.

Embodiments disclosed herein provide an antimicrobial composition contains a ginseng extract and a green tea extract as active ingredients. The ginseng extract and the green tea extract may be present in a weight ratio of about 60:40 to 70:30.

The ginseng extract may be selected from a group consisting of a ginseng leaf extract, a ginseng rootlet extract, a ginseng main root extract, and a combination thereof. The ginseng extract may be selected from a group consisting of a ginseng extract, a concentrated ginseng extract, a dried ginseng extract, and a combination thereof, and the green tea extract may be selected from a group consisting of a green tea extract, a concentrated green tea extract, a dried green tea extract, and a combination thereof.

Embodiments disclosed herein provide a method for preparing an antimicrobial composition includes preparing a ginseng extract, preparing a green tea extract, and mixing the ginseng extract with the green tea extract. The ginseng extract and the green tea extract may be mixed at a weight ratio of about 60:40 to 70:30.

Each of the preparation of the ginseng extract and the preparation of the green tea extract may further include powderizing the prepared extract, and the powderizing may be carried out by concentrating each of the extracts under reduced pressure. The preparation of the ginseng extract may include grinding any one selected from a group consisting of ginseng leaves, ginseng rootlets, ginseng main roots, and a combination thereof to prepare ground ginseng, mixing the ground ginseng with distilled water and sterilizing the resulting mixture, and drying the mixture and extracting the dried mixture with a solvent. The preparation of the green tea extract may include grinding green tea to prepare ground green tea, mixing the ground green tea with distilled water and sterilizing the resulting mixture, and drying the mixture and extracting the dried mixture with a solvent.

Embodiments disclosed herein provide an antimicrobial filter contains a ginseng extract and a green tea extract. The ginseng extract and the green tea extract may be present in a weight ratio of about 60:40 to 70:30.

The antimicrobial filter may further include any one selected from a group consisting of an antimicrobial substance, a binder, a metal, and a combination thereof. The antimicrobial substance may include any one selected from a group consisting of glutaraldehyde, phthalaldehyde (PA), potassium disulfite (PD), bronopol, sodium deoxycholate, quaternary ammonium, and a combination thereof.

The binder may include any one selected from a group consisting of polyvinylpyrrolidone iodine (PVPI), norspermidine (NS, bis(3-aminopropyl)octylamine), and a combination thereof. The binder may include any one selected from a group consisting of a silicone-modified epoxy resin, a silicone-modified acrylic resin, a silicone-modified urethane resin, a silicone-modified vinyl resin, a polyvinyl alcohol silicone resin, a urethane resin, an acrylic resin, a vinyl resin, a silicone resin, and a combination thereof.

The metal may include any one selected from a group consisting of Ag, Cu, Zn, Ca, Mn, and a combination thereof. The antimicrobial filter may be used for an air conditioner, an air cleaner, a refrigerator or a facial treatment device.

It will be apparent to those skilled in the art that various modifications and variations can be made without departing from the spirit or scope. Thus, it is intended that embodiments cover modifications and variations provided they come within the scope of the appended claims and their equivalents.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An antimicrobial composition for air conditioning filters, wherein the composition comprises a ginseng extract and a green tea extract, the ginseng extract and the green tea extract being present in a weight ratio of about 60:40 to 70:30.

2. The antimicrobial composition according to claim 1, wherein the ginseng extract is selected from a group consisting of a ginseng leaf extract, a ginseng rootlet extract, a ginseng main root extract, and a combination thereof.

3. The antimicrobial composition according to claim 1, wherein the ginseng extract is selected from a group consisting of a ginseng extract, a concentrated ginseng extract, a dried ginseng extract, and a combination thereof, and the green tea extract is selected from a group consisting of a green tea extract, a concentrated green tea extract, a dried green tea extract, and a combination thereof.

4. A method for preparing the antimicrobial composition for air conditioning filters according to claim 1, the method comprising:
preparing a ginseng extract;
preparing a green tea extract; and
mixing the ginseng extract with the green tea extract, wherein the mixing comprises mixing the ginseng extract with the green tea extract at a weight ratio of about 60:40 to 70:30.

5. The method according to claim 4, wherein each of the preparing the ginseng extract and the preparing the green tea extract further comprises powderizing the prepared extract, and wherein the powderizing is carried out by concentrating each of the extracts under reduced pressure.

6. The method according to claim 4, wherein the preparing the ginseng extract comprises:
grinding any one selected from a group consisting of ginseng leaves, ginseng rootlets, ginseng main roots, and a combination thereof to prepare ground ginseng;
mixing the ground ginseng with distilled water and sterilizing the resulting mixture; and
drying the mixture and extracting the dried mixture with a solvent.

7. The method according to claim 4, wherein the preparing the green tea extract comprises:
grinding green tea to prepare ground green tea;
mixing the ground green tea with distilled water and sterilizing the resulting mixture; and
drying the mixture and extracting the dried mixture with a solvent.

8. An antimicrobial filter comprising the antimicrobial composition for air conditioning filters according to claim 1.

9. The antimicrobial filter according to claim 8, wherein the antimicrobial filter further comprises any one selected from a group consisting of an antimicrobial substance, a binder, a metal, and a combination thereof.

10. The antimicrobial filter according to claim 9, wherein the antimicrobial substance comprises any one selected from a group consisting of glutaraldehyde, phthalaldehyde (PA), potassium disulfite (PD), bronopol, sodium deoxycholate, quaternary ammonium, and a combination thereof.

11. The antimicrobial filter according to claim 9, wherein the binder comprises any one selected from a group consisting of polyvinylpyrrolidone iodine (PVPI), norspermidine (NS, bis(3-aminopropyl)octylamine), and a combination thereof.

12. The antimicrobial filter according to claim 9, wherein the binder comprises any one selected from a group consisting of a silicone-modified epoxy resin, a silicone-modified acrylic resin, a silicone-modified urethane resin, a silicone-modified vinyl resin, a polyvinyl alcohol silicone resin, a urethane resin, an acrylic resin, a vinyl resin, a silicone resin, and a combination thereof.

13. The antimicrobial filter according to claim 9, wherein the metal comprises any one selected from a group consisting of Ag, Cu, Zn, Ca, Mn, and a combination thereof.

14. An air conditioner comprising the antimicrobial filter according to claim 8.

15. An air cleaner comprising the antimicrobial filter according to claim 8.

16. A refrigerator comprising the antimicrobial filter according to claim 8.

17. A facial treatment device comprising the antimicrobial filter according to claim 8.
